(19) United States
(12) Patent Application Publication
(10) Pub. No.: US 2026/0252160 A1
(43) Pub. Date: Aug. 27, 2026

(54) LIGHT SLEEP FEATURE FOR CACHE MEMORY

(71) Applicant: QUALCOMM Incorporated, San Diego, CA (US)

(72) Inventors: Shyam SUNDAR, Los Altos, CA (US); Xiao CHEN, San Diego, CA (US); Ramesh ARVAPALLI, Georgetown, TX (US); Hoan Huu NGUYEN, Cary, NC (US); Raghava Rao DENDULURI, Cupertino, CA (US)

(21) Appl. No.: 19/065,762

(22) Filed: Feb. 27, 2025

(51) Int. Cl. G06F 1/3234; G06F 1/3296; G06F 12/0811

(52) U.S. Cl. CPC G06F 1/3275; G06F 1/3296; G06F 12/0811

(57) ABSTRACT

Certain aspects of the present disclosure provide techniques and apparatus for controlling a cache. According to certain aspects, at least one sub bank of a memory instance of the cache is placed in in a first low power state by 1) placing a bit line of at least one sub bank of the memory instance in a floating state, and 2) adjusting a core bias to reduce a level of a supply voltage rail to the sub bank from an active level to a retention level.

### TECHNICAL FIELD

Aspects of the present disclosure generally relate to techniques and apparatus for reducing leakage current in a cache memory.

### BACKGROUND

A Last Level Cache (LLC) generally refers to a cache memory that sits closest to main memory in a multi-core processing systems memory hierarchy. An LLC typically serves as a buffer between the faster, smaller caches (like L1 and L2) and the slower, larger main memory (random access memory or RAM). An LLC is designed to reduce the latency and improve the efficiency of memory access by storing frequently accessed data and instructions that are not present in the upper-level caches. Unlike caches (e.g., L1 and L2 caches) that are typically local/private to individual cores, an LLC is typically shared among multiple cores, allowing it to serve as a unified cache that optimizes data access across the entire CPU.

### BRIEF SUMMARY

One aspect provides a method for controlling a cache. The method includes placing at least one sub bank of memory instance of the cache in a first low power state by 1) placing a bit line of at least one sub bank of the memory instance in a floating state, and 2) adjusting a core bias to reduce a level of a supply voltage rail to the sub bank from an active level to a retention level; and bringing the at least one sub bank out of the low power state prior to an access.

Other aspects provide: an apparatus operable, configured, or otherwise adapted to perform any one or more of the aforementioned methods and/or those described elsewhere herein; a non-transitory, computer-readable media comprising instructions that, when executed (e.g., directly, indirectly, after pre-processing, without pre-processing) by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the related drawings set forth in detail certain illustrative features of one or more aspects.

### BRIEF DESCRIPTION OF THE DRAWINGS

The appended figures depict certain features of one or more aspects of the present disclosure and are therefore not to be considered limiting of the scope of this disclosure.

FIG. 1 depicts an example CPU cluster according to various aspects of the present disclosure.

FIG. 2 depicts example components of a CPU according to various aspects of the present disclosure.

FIG. 3 depicts an example configuration of a last level cache (LLC) according to various aspects of the present disclosure.

FIG. 4 depicts additional details of an example configuration of an LLC according to various aspects of the present disclosure.

FIGS. 5A and 5B depict example control signals for a light sleep state according to various aspects of the present disclosure.

FIG. 6 depicts example timing for a light sleep according to various aspects of the present disclosure.

FIGS. 7A and 7B depict example circuitry and timing for a light sleep state according to various aspects of the present disclosure.

FIG. 8 depicts a flow diagram of an example method for communicating SME requests to a hardware accelerator according to various aspects of the present disclosure.

FIG. 9 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure generally relate to techniques and apparatus for reducing leakage current in a cache memory, such as a last level cache (LLC).

Due to its strategic position and shared nature, an LLC may significant impact overall system performance, especially in multi-threaded and multi-core environments. An LLC is designed to hold larger amounts of data, typically in the megabytes range, compared to the kilobyte-sized L1 and L2 caches. While the access time for the LLC is longer than the upper-level caches but considerably faster than accessing the main memory. By reducing the number of direct accesses to main memory, the LLC may help reduce performance bottlenecks associated with memory access latency, thus improving the throughput and efficiency of the system as a whole.

Current designs of processors, such as central processing units (CPUs), are typically expected to meet relatively stringent performance metrics on various benchmarks. The strategic use of larger cache sizes, including LLC sizes, is one approach to help achieve this. Larger cache sizes, however, consume more leakage and impacts lower power use cases and affects battery life.

LLCs are typically built using Static Random-Access Memory (SRAM) due to its high speed and low access latency. Leakage current in SRAM refers to the relatively small, constant electrical current that flows through the transistors even when they are not actively switching. Leakage occurs due to the inherent properties of the transistors, primarily from subthreshold leakage, gate leakage, and junction leakage, and becomes more significant as transistor sizes shrink in advanced semiconductor processes. In large LLCs, the accumulated leakage current can lead to substantial power consumption, even when the cache is idle. This power dissipation not only affects the overall energy efficiency of the processor but also generates heat, which can impact the thermal management of the system.

In an LLC, the data array is the primary memory which is proportional to the cache size and large number of instances of data array are used to build the cache. When the LLC data array is not accessed it is still in an active state (with power switches ON) and consume significant leakage on memory rails, which may adversely impact battery life. LLC data memories typically cannot be powered down completely, as the latency involved to wake them up for an access is high and would adversely impact the performance.

Aspects of the present disclosure provide mechanisms that may help reduce the leakage power with little or no impact on access latency. As a result, the mechanisms presented herein may help improve energy efficiency of the processor, which may help increase battery life and improve overall user experience.

### Example CPU Cluster

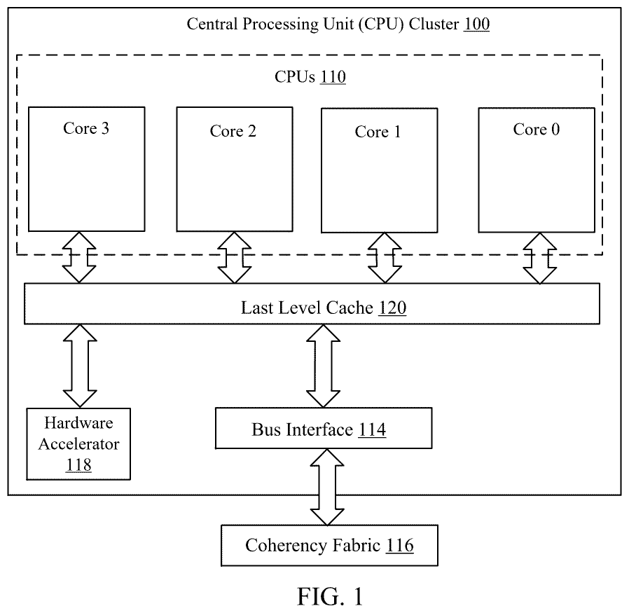

FIG. 1 depicts a block diagram of a CPU cluster 100 according to certain aspects of the present disclosure. For example, the techniques proposed herein may be used to reduce leakage of a last level cache (LLC), such as LLC 120.

The CPU cluster 100 may include a plurality of CPUs 110. For example, as illustrated in FIG. 1, the CPU cluster 100 may include four separate CPUs (e.g., labeled as Core 0, Core 1, Core 2, and Core 3). It should be appreciated that the scope of the present disclosure is not intended to be limited to CPU clusters having four separate CPUs and therefore may include CPU clusters having more or fewer CPUs 110.

The CPU cluster 100 may include a LLC 120 having a much larger storage capacity compared to local memory (e.g., level 1 cache) included in each respective CPU 110 of the CPU cluster 100. The LLC 120 may be shared amongst the plurality of CPUs 110. Also, as the name suggests, the LLC 120 represents the final cache before a respective CPU of the plurality of CPUs 110 access the main memory.

The CPU cluster 100 may include a bus interface 114. The bus interface 114 may be a physical (and logical) interface that connects a respective CPU to other components. For example, the bus interface 114 may connect the respective CPU to a coherency fabric 116 (e.g., system bus) that connects the respective CPU to another CPU cluster (not shown) as well as other components, such as main memory.

The CPU cluster 100 may include a hardware accelerator 118 configured to execute computationally intensive tasks (e.g., matrix multiplication). The hardware accelerator 118 may be in communication with each respective CPU of the CPUs 110 via the LLC 120. The hardware accelerator 118 may include two separate pipelines. For example, in some aspects, the two separate pipelines may include a load-store unit (LSU) execution pipeline and a matrix multiplication pipeline. In this manner, the hardware accelerator 118 may be configured to execute two instructions, such as two SME requests, per clock cycle.

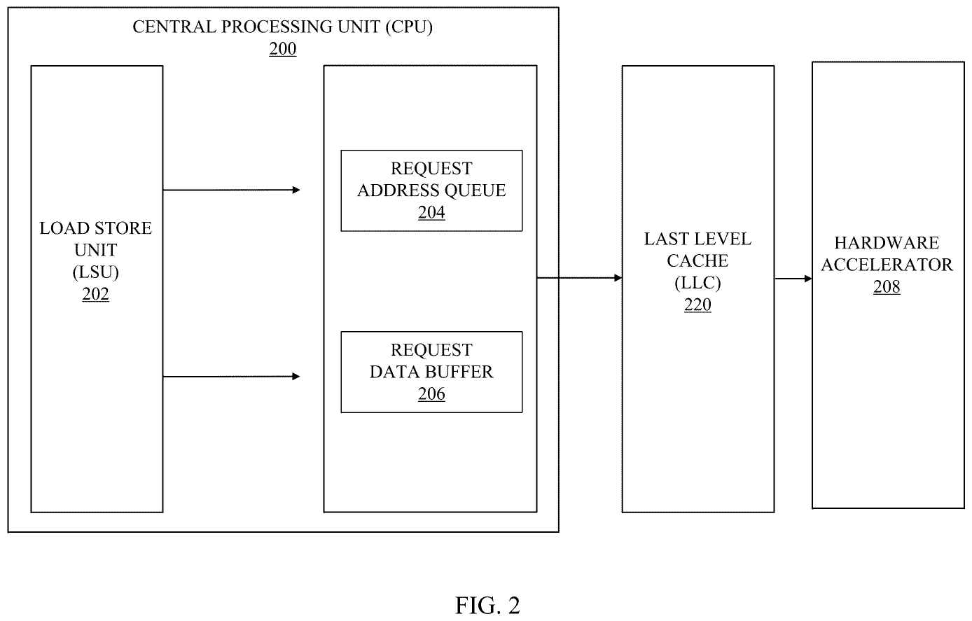

FIG. 2 illustrates components of a CPU 200 according to some aspects of the present disclosure. For example, the CPU 200 may be one of the CPUs 110 included in the CPU cluster 100 discussed above with reference to FIG. 1.

In some aspects, the CPU 200 may include a load-store unit (LSU) 202, a request address queue (RAQ) 204, and a request data buffer (RDB) 206. The LSU 202 may be configured to provide instructions to a hardware accelerator 208 via a last level cache (LLC) 220. For example, in some aspects, the instructions that the LSU 202 provides to the hardware accelerator 208 may include SME requests, scalable vector extension (SVE) requests, or both. In some aspects, SVE instruction set may include instructions that operate on one-dimensional vectors with a scalable length, whereas the SME instruction set may be an extension of SVE instruction set and may include instructions that operate on two-dimensional matrices with fixed dimensions. To send instructions (that is, SME requests, SVE requests, or both) to the hardware accelerator 208 via the LLC 220, the CPU 200 may, in some aspects, enter a streaming mode.

It should be appreciated that the SME may support various computationally-intensive tasks, such as matrix operations that, without limitation, may include: taking the transpose of a matrix; calculating the matrix outer product of vector; and loading/storing matrix vectors. It should also be appreciated that the hardware accelerator 208 may include dedicated matrix processing cores (e.g., CPUs) that can accelerate the computation of matrix-matrix, matrix-vector, and vector-vector operations.

In some aspects, the LSU 202 may be configured to provide a packet (e.g., including at least one of an opcode and a payload) that includes an SME request (e.g., instruction in the SME instruction set) for the hardware accelerator 208. For example, the CPU 200 may be configured to provide a first type of packet (e.g., referred to as SME data path) for the matrix execution pipeline of the hardware accelerator 208 and a second type of packet (e.g., referred to as a SME Load/Store) for the LSU execution pipeline of the hardware accelerator 208.

It should be appreciated that the matrix execution pipeline of the hardware accelerator 208 and the LSU execution pipeline of the hardware accelerator 208 may be independent processing paths included in the architecture of the hardware accelerator 208. For example, the LSU execution pipeline may be configured for efficient memory access to ensure that data can be fetched from or written to memory with minimal latency and therefore may include hardware components (e.g., memory controller, address generation units, data buffers, etc.) to facilitate such efficient memory accesses with minimal latency. The matrix execution pipeline may be configured for performing arithmetic and logical operations on data and therefore may include hardware components configured to efficiently execute the arithmetic and logical operations associated with target applications (e.g., matrix operations, convolutions, etc.) of the hardware accelerator 208. By separating the load-store execution pipeline and the matrix execution pipeline, the hardware accelerator 208 may experience improved throughput and reduced latency associated with memory accesses.

It should be appreciated that an opcode that is included in a given SME request may be a numerical code that represents a specific instruction of the plurality of different SME instructions that can be included in the given SME request. It should also be appreciate that a payload may refer to the actual data that the hardware accelerator 208 may manipulate based on the opcode included in the given SME request.

In some aspects, the size of the packet may range from 1-word (e.g., 8 bits) to 5-words (e.g., 40 bits) depending on the packet type (e.g., first type for the matrix execution pipeline or second type for the LSU execution pipeline). Furthermore, in some aspects, the format of the packet may vary based on the type of packet. For example, the second type of packet (e.g., SME Load/Store) may follow the following format: opcode (1-word); packet type; physical address; memory/ordering attribute; coherent/non-coherent memory; and region table pointer (4K memory region to which load is performed).

In some aspects, the RAQ 204 may be configured to track packets (e.g., including SME requests) for the hardware accelerator 208. The RAQ may also be further configured to track load/store requests for the CPU 200. In this manner, the RAQ 204 may be considered a shared structure. Furthermore, the RDB 206 may receive the packets (e.g., including an op-code and payload) from the LSU 202 that are intended for the hardware accelerator 208.

In some aspects, the RDB 206 may be configured to store packets (e.g., including SME requests) for the hardware accelerator 208. The LLC 220 may be configured to obtain a packet stored in the RDB 206 and, as soon as the LLC 220 obtains the packet, information associated with an SME request included in the packet may be removed (e.g., dequeued) from the RAQ 204. In this manner, by removing information stored in the RAQ 204 and associated with a given SME request as the LLC 220 obtains the given SME requests from the RDB 206, the RAQ 204 may provide an up-to-date (e.g., current) accounting of SME requests remaining for the hardware accelerator to execute.

It should be appreciated that, in some aspects, the LLC 220 may support a 32-byte interface that may be used to retrieve packets from the CPU 200, specifically the RDB 206 thereof, and provide the packets to the hardware accelerator 208. In other aspects, the LLC 220 may support an even larger interface. For example, in some aspects, the LLC 220 may support a 64-byte interface.

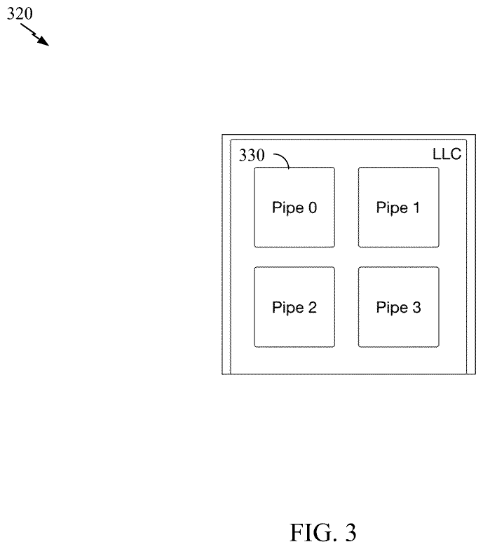

The CPU 200 may support a throughput of two instructions (e.g., SME requests) per clock cycle from the LSU 202 to the RAQ 204 and RDB 206. In some aspects, the CPU 200 may support a higher throughput, such as 4 instructions per clock cycle from the LSU 202 to the RAQ 204 and RDB 206. With existing approaches though, the instructions are enqueued in the RAQ 204 and the RDB 206 without any merging. And, without merging the instructions, the CPU 200 can only sustain a throughput of less than 1 instruction per clock cycle to the hardware accelerator 208. This sub-optimal throughput of instructions (e.g., SME requests) from the LSU 202 of the CPU 200 to the hardware accelerator 208 may result in waste, such as increased idle time of the hardware accelerator 208 given the instruction throughput (e.g., 2 instructions per clock cycle) of the hardware accelerator 208 is higher than the instruction throughput (e.g., less than 1 instruction per clock cycle) of the CPU 200. As will now be discussed with reference to FIG. 3, techniques disclosed herein involve merging multiple instructions (e.g., SME requests) stored in the RDB 206 to improve the instruction throughput from the CPU 200 to the hardware accelerator 208 to eliminate (or at least reduce) waste (e.g., increased idle time) that occurs when the instruction throughput of the CPU 200 is less than the instruction throughput of the hardware accelerator 208.

### Example LLC Light Sleep Feature

As noted above, large LLC sizes may help current CPU designs meet relatively stringent performance metrics on various benchmarks. Larger cache sizes, however, consume more leakage and impacts lower power use cases and affects battery life.

When the LLC data array is not accessed it is still in an active state (with power switches ON) and consume significant leakage on memory rails, which may adversely impact battery life. LLC data memories typically cannot be powered down completely, as the latency involved to wake them up for an access is high and would adversely impact the performance.

Aspects of the present disclosure provide mechanisms that may help reduce the leakage power with little or no impact on access latency.

The mechanisms may be referred to as a light sleep feature. This is because the light sleep mechanisms may keep memory in a retention state at a higher voltage than a deep (or deeper) sleep mechanism, which may allow for a reduced wake-up time. As a result, the light sleep mechanisms proposed herein may help reduce leakage with little or no latency penalty.

A cache memory may be partitioned into structures that may be referred to as pipes. In a cache memory, a pipe may function as a buffer because it may essentially act as a temporary storage location for data that is being transferred between different parts of a system, allowing for faster access and smoother data flow. An LLC cache may be partitioned into multiple pipes, depending on the particular design.

For example, FIG. 3 illustrates an example LLC 320 that is broken into 4 pipes 330. In such a design, each pipe 330 may cover (e.g., house) ¼^{th} of the total cache size. Each pipe 330 may be designed to operate independently and to be accessed simultaneously for better throughput.

To support high memory-level parallelism (MLP), LLCs are typically divided into multiple banks, allowing parallel access. In other words, each bank is a separate area within the LLC that can be accessed independently.

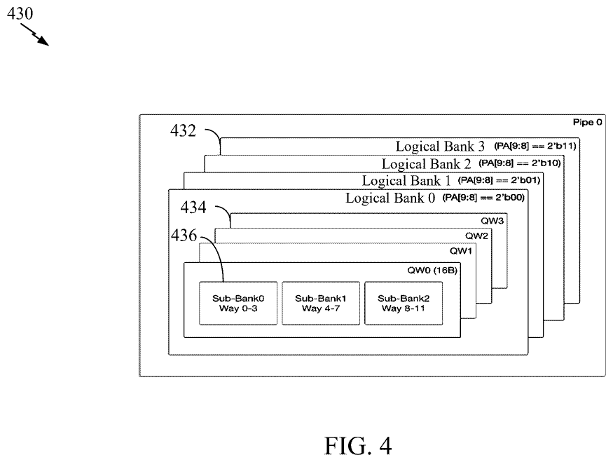

FIG. 4 illustrates an example of a pipe (Pipe 0) 430 divided into four logical banks 432. As illustrated, each bank 432 may be selected by two physical address (PA) bits [9:8]: Bank 0 with PA[9: 8]='00', Bank 1 with PA[9: 8]='01', Bank 2 with PA[9: 8]=‘10’, and Bank 3 with PA[9:8]=‘11’.

The 4 logical banks 432 may be accessed in successive cycles. Each sub-bank within the logical bank has 4 cycle access time. As illustrated, each logical bank may be further divided into sub-banks 436. The example assumes a 12-way cache. In this context, a “way” represents one of the multiple potential places a memory address can map to within a particular set of the cache, allowing for a set-associative cache design where data can be stored in multiple locations within a set depending on the cache.

According to aspects of the present disclosure, if the data array is not actively accessed the (corresponding portions) of memory may be placed in the light sleep state. As will be described in greater detail below, in the light sleep state, various types of internal circuits may be enabled and to reduce the leakage.

A first circuit may be configured to place a bit line in a floating state, instead of an active pre-charge. A second circuit may be configured to adjust core biasing to reduce the array voltage to a retention level.

In some cases, separate control signals may be used to control these two different circuit features for different sub-banks, which may provide flexibility.

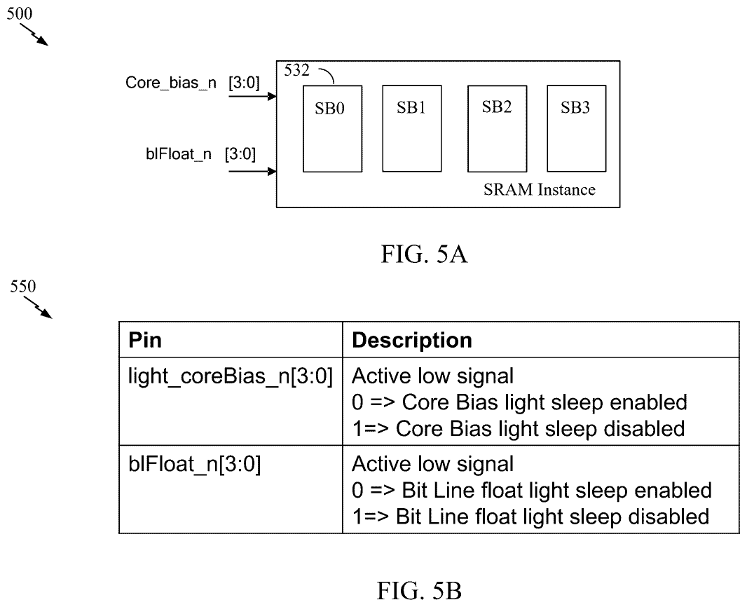

For example, as illustrated in FIG. 5A, there may be 8 such control signals, allowing flexible control of the two circuit features for 4 sub banks 532 inside one SRAM instance 500. In the illustrated example, a first set of control signals, light_coreBias_n[3:0], allows independent control of the core biasing of each bank, while a second set of control signals, blFloat_n[3:0], allows independent control of the bitline floating of each bank.

As illustrated in table 550 of FIG. 5B, light_coreBias_n[3:0] may be active low signals, with bit values of ‘0 ’ enabling the core bias voltage corresponding to the light sleep state (e.g., bringing a virtual V_{DD} to a retention level). Similarly, blFloat_n[3:0] may also be active low signals, with bit values of ‘0 ’ causing corresponding bit lines to float (e.g., with pre-charge disabled).

This organization and design of the various control signals may provide flexibility to enable/disable individual circuit features based on different operating voltage and frequency points.

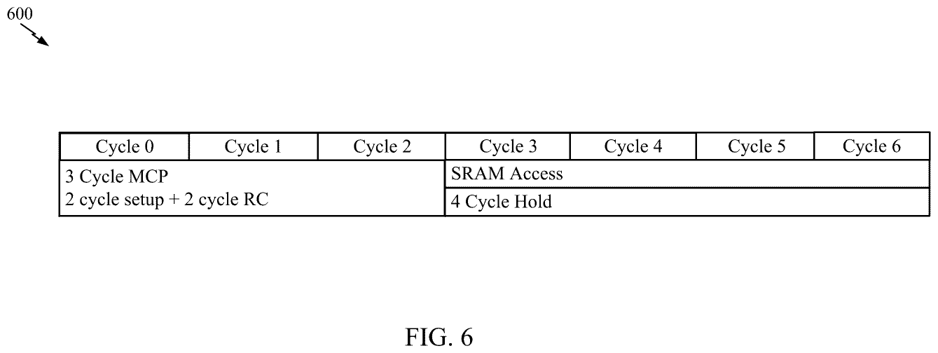

The control mechanisms proposed herein may allow certain timing objectives to be met. For example, as illustrated in table 600 of FIG. 6, there may be a 3 cycle duration/latency (e.g., a 2 cycle setup and 1 cycle propagation delay) for setup paths on sleep control signals to the SRAM memory instance and a 4 cycle hold time.

Waking up of large SRAM memory instances results in high in-rush current and power delivery network (PDN) issues. The flexible design proposed herein, with separate control signals for different banks, along with the unique addressing of the logic banks and SRAM banks may help to wake up a limited number of memory instances in a controlled manner. In other words, the different control signals may be used to bring different sub banks out of the low power (light sleep) state in different stages to limit current in-rush, with little or no additional access latency.

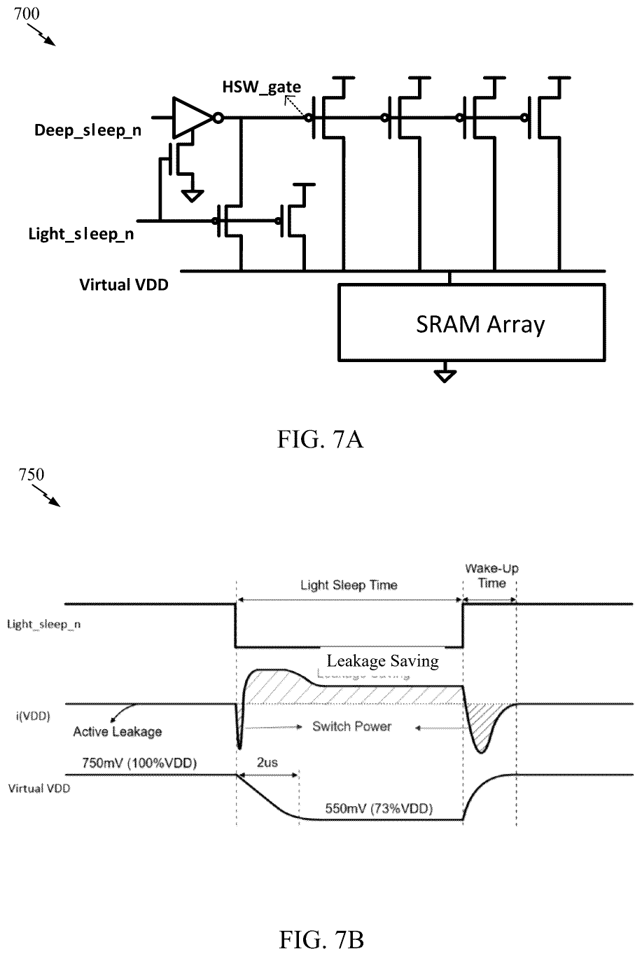

Diagram 700 of FIG. 7 illustrates how the control signals proposed herein may be used to control core bias voltage and bit-line floating to implement the light sleep feature proposed herein for an example bank “n.” The control signal light_sleep_n=0 to enable the light sleep mode, may correspond to a state where corresponding control signals light_coreBias_n and blFloat_n for a given bank are both 0.

As illustrated, to achieve high speed operation, in a light sleep state a voltage modulator (e.g., PMOS keeper) may be deployed to sustain virtual V_{DD} at a retention level (e.g., controlled by light_sleep_n=0) where it can be waked up from light sleep within 1 cycle before active CLK comes. This retention level may be set to a higher level than a retention level in a deeper sleep state (controlled by deep_sleep_n=0) that might have a higher associated wake-up time).

In this context, virtual V_{DD} may refer to a gated supply voltage rail where a virtual power supply is created to selectively turn off the power supply to unused portions of the cache memory. This approach may significantly reduce leakage power consumption by essentially “gating” the voltage to those areas; essentially acting like a virtual power rail that can be dynamically controlled based on cache usage.

As illustrated in the example simulation diagram 750 of FIG. 7B, when the memory is placed in the light sleep state (light_sleep_n=0), there may be significant leakage savings. As noted above, during the light sleep mode, the bit-line may be placed in a floating state, with pre-charge disabled, resulting in the reduction in bitcell leakage.

In the illustrated example, the virtual V_{DD} is lowered from 100% (e.g., 750 mV) to 73% (e.g., 550 mV). The values may be selected to achieve a fast wake-up time when waking the memory up from the light sleep mode (e.g., light_sleep_n=0).

In some cases, the light sleep mechanisms proposed herein may be used in conjunction with a dynamic voltage and frequency scaling (DVFS) scheme. DVFS may allow processor cores to switch between voltage and frequency levels (e.g., voltage/frequency points) based on real-time workload demands, automatically adjusting performance and power consumption.

As an example, a processor or memory could have DVFS table entries with different voltage levels and corresponding frequencies. In some cases, each DVFS entry may correspond to a performance state (p-state). In general, higher p-states will have higher frequencies and correspondingly to higher voltages, while lower p-states will have lower frequencies and corresponding lower voltages to save power.

In some cases, the light sleep feature proposed herein may be used only in certain p-states. For example, in some cases, the light sleep feature may be used only in lower performance states, due to the wake-up time. This is because higher performance states may want to avoid the additional wake up time, regardless of how small. Further, in some cases, different bias voltages (e.g., one or more virtual VDD levels) may be used for different p-states and/or at different times to optimize leakage savings and/or wake-up times.

### Example Method for Communicating SME Requests to a Hardware Accelerator

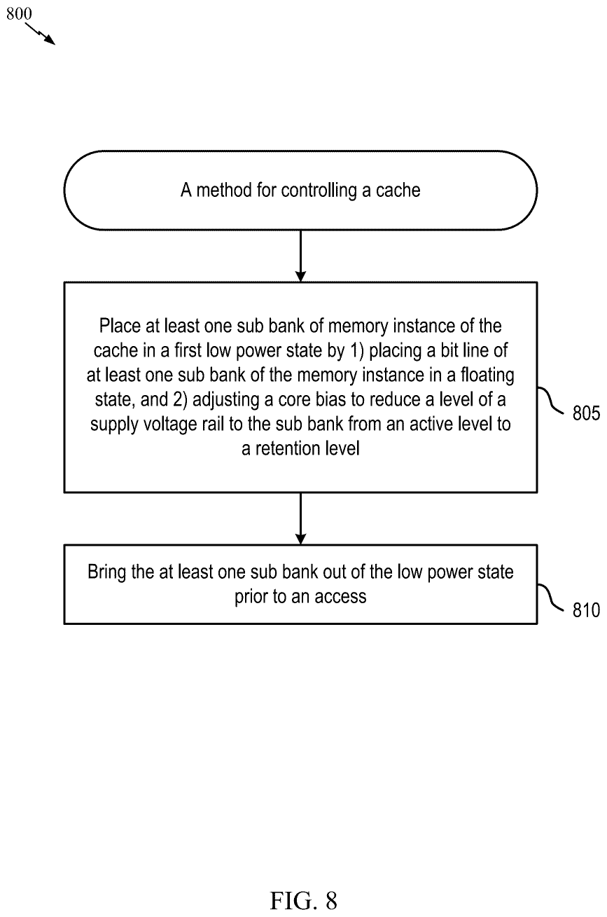

FIG. 8 shows an example of a method 800.

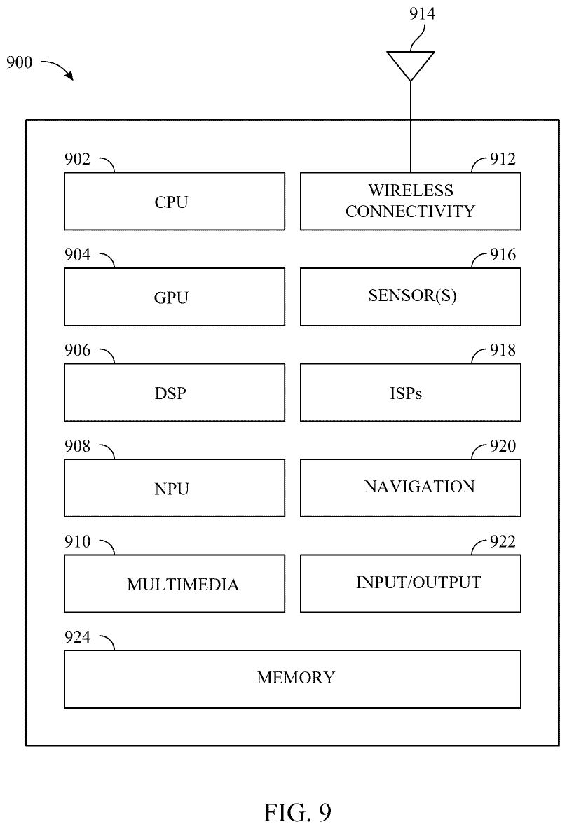

Method 800 begins at step 805 with placing at least one sub bank of memory instance of the cache in a first low power state by 1) placing a bit line of at least one sub bank of the memory instance in a floating state, and 2) adjusting a core bias to reduce a level of a supply voltage rail to the sub bank from an active level to a retention level. In some cases, the operations of this step refer to, or may be performed by, circuitry for placing and/or code for placing as described with reference to FIG. 9.

Method 800 then proceeds to step 810 with bringing the at least one sub bank out of the low power state prior to an access. In some cases, the operations of this step refer to, or may be performed by, circuitry for bringing and/or code for bringing as described with reference to FIG. 9.

In some aspects, the retention level is different than a voltage level of the supply voltage rail during a second low power state.

In some aspects, pre-charging of the bit line is disabled while the at least one sub bank is in the low power state; and the bit line is pre-charged when bringing the at least one sub bank out of the low power.

In some aspects, the supply voltage rail comprises a virtual supply voltage rail; and the retention level is designed to allow the at least one sub bank to be brought out of the low power state within one cycle before an active clock signal.

In some aspects, the bit line is placed in the floating state via a first control signal of a set of first control signals that allow different sub banks to be independently placed in the floating state; and the core bias is adjusted via a second control signal of a set of second control signals that allow the core bias of different sub banks to be independently adjusted.

In some aspects, a quantity of first control signals in the set of first control signals is equal to a number of sub banks in the memory instance; and a quantity of second control signals in the set of second control signals is equal to the number of sub banks in the memory instance.

In some aspects, the method 800 further includes using the first and second sets of control signals to bring different sub banks out of the low power state in different stages. In some cases, the operations of this step refer to, or may be performed by, circuitry for using and/or code for using as described with reference to FIG. 9.

In some aspects, the method 800 further includes using the first and second sets of control signals to set the supply voltage rail to different levels in the different stages. In some cases, the operations of this step refer to, or may be performed by, circuitry for using and/or code for using as described with reference to FIG. 9.

In some aspects, the at least one sub bank of the memory instance is placed in the first low power state only during certain performance states.

In some aspects, the certain performance states are associated with certain operating voltage and frequency points.

In one aspect, method 800, or any aspect related to it, may be performed by an apparatus, such as processing system 900 of FIG. 9, which includes various components operable, configured, or adapted to perform the method 800. Processing system 900 is described below in further detail.

Note that FIG. 8 is just one example of a method, and other methods including fewer, additional, or alternative steps are possible consistent with this disclosure.

### Example Processing System for Communicating SME Requests

In some aspects, the techniques and methods described with reference to FIGS. 2-8 may be implemented on one or more devices or systems. FIG. 9 depicts an example processing system 900 configured to perform various aspects of the present disclosure, including, for example, the techniques and methods described with respect to FIGS. 2-8. In some aspects, the processing system 900 may include the CPU cluster 100 discussed above with reference to FIG. 1. Although depicted as a single system for conceptual clarity, in some aspects, as discussed above, the operations described below with respect to the processing system 900 may be distributed across any number of devices or systems.

The processing system 900 includes a central processing unit (CPU) 902 (e.g., corresponding to one of the CPUs 110 of FIG. 1). Instructions executed at the CPU 902 may be loaded, for example, from a cache memory associated with the CPU 902.

The processing system 900 also includes additional processing components tailored to specific functions, such as a graphics processing unit (GPU) 904, a digital signal processor (DSP) 906, a neural processing unit (NPU) 908, a multimedia component 910 (e.g., a multimedia processing unit), and a wireless connectivity component 912.

The one or more processors of processing system 900 may include circuitry configured to implement (e.g., execute) code stored in a computer-readable medium/memory, including circuitry such as circuitry for placing, circuitry for bringing, and circuitry for using. Processing with circuitry for placing, circuitry for bringing, and circuitry for using may cause the processing system 900 to perform the method 800 described with respect to FIG. 8, or any aspect related to it.

An NPU, such as NPU 908, is generally a specialized circuit configured for implementing the control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 908, are configured to accelerate the performance of common machine learning tasks, such as image classification, machine translation, object detection, and various other predictive models. In some examples, a plurality of NPUs may be instantiated on a single chip, such as a SoC, while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this piece of data through an already trained model to generate a model output (e.g., an inference).

In some implementations, the NPU 908 is a part of one or more of the CPU 902, the GPU 904, and/or the DSP 906.

In some examples, the wireless connectivity component 912 may include subcomponents, for example, for third generation (3G) connectivity, fourth generation (4G) connectivity (e.g., 4G Long-Term Evolution (LTE)), fifth generation connectivity (e.g., 5G or New Radio (NR)), Wi-Fi connectivity, Bluetooth connectivity, and/or other wireless data transmission standards. The wireless connectivity component 912 is further coupled to one or more antennas 914.

The processing system 900 may also include one or more sensor processing units 916 associated with any manner of sensor, one or more image signal processors (ISPs) 918 associated with any manner of image sensor, and/or a navigation processor 920, which may include satellite-based positioning system components (e.g., GPS or GLONASS), as well as inertial positioning system components.

The processing system 900 may also include one or more input and/or output devices 922, such as screens, touch-sensitive surfaces (including touch-sensitive displays), physical buttons, speakers, microphones, and the like.

In some examples, one or more of the processors of the processing system 900 may be based on an ARM or RISC-V instruction set.

The processing system 900 also includes the memory 924, which is representative of one or more static and/or dynamic memories, such as a dynamic random access memory, a flash-based static memory, and the like. In this example, the memory 924 includes computer-executable components, which may be executed by one or more of the aforementioned processors of the processing system 900.

Generally, the processing system 900 and/or components thereof may be configured to perform the methods described herein.

Notably, in other aspects, elements of the processing system 900 may be omitted, such as where the processing system 900 is a server computer or the like. For example, the multimedia component 910, the wireless connectivity component 912, the sensor processing units 916, the ISPs 918, and/or the navigation processor 920 may be omitted in other aspects. Further, aspects of the processing system 900 may be distributed between multiple devices.

### EXAMPLE CLAUSES

Implementation examples are described in the following numbered clauses:

Clause 1: A method for controlling a cache, comprising: placing at least one sub bank of memory instance of the cache in a first low power state by 1) placing a bit line of at least one sub bank of the memory instance in a floating state, and 2) adjusting a core bias to reduce a level of a supply voltage rail to the sub bank from an active level to a retention level; and bringing the at least one sub bank out of the low power state prior to an access.

Clause 2: The method of Clause 1, wherein the retention level is different than a voltage level of the supply voltage rail during a second low power state.

Clause 3: The method of any one of Clauses 1-2, wherein: pre-charging of the bit line is disabled while the at least one sub bank is in the low power state; and the bit line is pre-charged when bringing the at least one sub bank out of the low power.

Clause 4: The method of any one of Clauses 1-3, wherein: the supply voltage rail comprises a virtual supply voltage rail; and the retention level is designed to allow the at least one sub bank to be brought out of the low power state within one cycle before an active clock signal.

Clause 5: The method of any one of Clauses 1-4, wherein: the bit line is placed in the floating state via a first control signal of a set of first control signals that allow different sub banks to be independently placed in the floating state; and the core bias is adjusted via a second control signal of a set of second control signals that allow the core bias of different sub banks to be independently adjusted.

Clause 6: The method of Clause 5, wherein: a quantity of first control signals in the set of first control signals is equal to a number of sub banks in the memory instance; and a quantity of second control signals in the set of second control signals is equal to the number of sub banks in the memory instance.

Clause 7: The method of Clause 5, further comprising using the first and second sets of control signals to bring different sub banks out of the low power state in different stages.

Clause 8: The method of Clause 7, further comprising using the first and second sets of control signals to set the supply voltage rail to different levels in the different stages.

Clause 9: The method of any one of Clauses 1-8, wherein the at least one sub bank of the memory instance is placed in the first low power state only during certain performance states.

Clause 10: The method of Clause 9, wherein the certain performance states are associated with certain operating voltage and frequency points.

Clause 11: An apparatus, comprising: at least one memory comprising executable instructions; and at least one processor configured to execute the executable instructions and cause the apparatus to perform a method in accordance with any combination of Clauses 1-10.

Clause 12: An apparatus, comprising means for performing a method in accordance with any combination of Clauses 1-10.

Clause 13: A non-transitory computer-readable medium comprising executable instructions that, when executed by at least one processor of an apparatus, cause the apparatus to perform a method in accordance with any combination of Clauses 1-10.

Clause 14: A computer program product embodied on a computer-readable storage medium comprising code for performing a method in accordance with any combination of Clauses 1-10.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

For example, means for sending a first SME request to a buffer of a central processing unit (e.g., LSU 202 in FIG. 2) and means for sending a second SME request to the buffer (e.g., also LSU 202 in FIG. 2) may comprise one or more processors, such as one or more of the processors described above with reference to FIG. 9. Means for merging the first SME request in the buffer and second SME request in the buffer to generate a request packet (e.g., CPU 200 in FIG. 2) may comprise one or more processors, such as one or more of the processors described above with reference to FIG. 9. Means for sending the request packet to a hardware accelerator (e.g., LLC 220 in FIG. 2) may comprise one or more processors, such as one or more of the processors described above with reference to FIG. 9.

Means for placing, means for bringing, and means for using may comprise one or more processors, such as one or more of the processors described above with reference to FIG. 9.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for controlling a cache, comprising:
placing at least one sub bank of a memory instance of the cache in a first low power state by 1) placing a bit line of at least one sub bank of the memory instance in a floating state, and 2) adjusting a core bias to reduce a level of a supply voltage rail to the sub bank from an active level to a retention level; and
bringing the at least one sub bank out of the low power state prior to an access.

2. The method of claim 1, wherein the retention level is different than a voltage level of the supply voltage rail during a second low power state.

3. The method of claim 1, wherein:
pre-charging of the bit line is disabled while the at least one sub bank is in the low power state; and
the bit line is pre-charged when bringing the at least one sub bank out of the low power.

4. The method of claim 1, wherein:
the supply voltage rail comprises a virtual supply voltage rail; and
the retention level is designed to allow the at least one sub bank to be brought out of the low power state within one cycle before an active clock signal.

5. The method of claim 1, wherein:
the bit line is placed in the floating state via a first control signal of a set of first control signals that allow different sub banks to be independently placed in the floating state; and
the core bias is adjusted via a second control signal of a set of second control signals that allow the core bias of different sub banks to be independently adjusted.

6. The method of claim 5, wherein:
a quantity of first control signals in the set of first control signals is equal to a number of sub banks in the memory instance; and
a quantity of second control signals in the set of second control signals is equal to the number of sub banks in the memory instance.

7. The method of claim 5, further comprising using the first and second sets of control signals to bring different sub banks out of the low power state in different stages.

8. The method of claim 7, further comprising using the first and second sets of control signals to set the supply voltage rail to different levels in the different stages.

9. The method of claim 1, wherein the at least one sub bank of the memory instance is placed in the first low power state only during certain performance states.

10. The method of claim 9, wherein the certain performance states are associated with certain operating voltage and frequency points.

11. A processing system comprising:
a cache; and
memory control circuitry configured to
place at least one sub bank of a memory instance of the cache in a first low power state by 1) placing a bit line of at least one sub bank of the memory instance in a floating state, and 2) adjusting a core bias to reduce a level of a supply voltage rail to the sub bank from an active level to a retention level; and
bring the at least one sub bank out of the low power state prior to an access.

12. The processing system of claim 11, wherein the cache comprises a last level cache (LLC).

13. The processing system of claim 11, wherein the retention level is different than a voltage level of the supply voltage rail during a second low power state.

14. The processing system of claim 11, wherein:
pre-charging of the bit line is disabled while the at least one sub bank is in the low power state; and
the bit line is pre-charged when bringing the at least one sub bank out of the low power.

15. The processing system of claim 11, wherein:
the supply voltage rail comprises a virtual supply voltage rail; and
the retention level is designed to allow the at least one sub bank to be brought out of the low power state within one cycle before an active clock signal.

16. The processing system of claim 11, wherein the memory control circuitry configured to:
place the bit line in the floating state via a first control signal of a set of first control signals that allow different sub banks to be independently placed in the floating state; and
adjust the core bias via a second control signal of a set of second control signals that allow the core bias of different sub banks to be independently adjusted.

17. The processing system of claim 16, wherein:
a quantity of first control signals in the set of first control signals is equal to a number of sub banks in the memory instance; and
a quantity of second control signals in the set of second control signals is equal to the number of sub banks in the memory instance.

18. The processing system of claim 16, wherein the memory control circuitry is further configured to use the first and second sets of control signals to bring different sub banks out of the low power state in different stages.

19. The processing system of claim 18, wherein the memory control circuitry is further configured to use the first and second sets of control signals to set the supply voltage rail to different levels in the different stages.

20. An apparatus, comprising:
means for placing at least one sub bank of a memory instance of a cache in a first low power state by 1) placing a bit line of at least one sub bank of the memory instance in a floating state, and 2) adjusting a core bias to reduce a level of a supply voltage rail to the sub bank from an active level to a retention level; and
means for bringing the at least one sub bank out of the low power state prior to an access.
